(19) United States
(12) Patent Application Publication
(10) Pub. No.: US 2012/0137492 A1
(43) Pub. Date: Jun. 7, 2012

(54) Calcium Hydroxide Mixing Device

(76) Inventor: John Kossik, Mill Creek, WA (US)

(21) Appl. No.: 13/295,090

(22) Filed: Nov. 13, 2011

Related U.S. Application Data
(60) Provisional application No. 61/419,735, filed on Dec. 3, 2010.

(51) Int. Cl. B23P 11/00

(52) U.S. Cl. 29/428

(57) ABSTRACT

A Mixing Device for contacting solid and liquid materials is described. The device consists of two vertically oriented cylinders, one of larger diameter mounted on top of one of a smaller diameter connected by a concentric transition piece. The device facilitates solid/liquid contact with no moving parts via a nozzle at the end of an inlet pipe. The nozzle creates impingement of a high velocity liquid on solids confined in the bottom smaller diameter cylinder. As the resulting mixture travels up into the larger diameter cylinder its velocity is greatly reduced due to the change in cross-sectional area of flow, allowing the solid and liquid time to separate under the influence of gravity before any solids reach the outlet of the device located at the top of the larger diameter cylinder.

### CROSS-REFERENCE TO RELATED APPLICATIONS

US PATENT DOCUMENTS

I would like to claim Priority of the Provisional Application 61/419,735.

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

To maintain saltwater aquariums containing corals and other calcium-metabolizing animals, calcium supplementation is required to replace that used by these creatures. There are three methods traditionally used to effect this addition. The first is the direct addition of a calcium salt like calcium chloride (CaCl₂) to the aquarium water itself. This method has the advantage of raising the calcium concentration directly without changing other chemistry parameters in the system. Unfortunately these materials are often times expensive, must be done continually, and do not help balance the alkalinity values in the aquarium.

The second method of calcium supplementation is the use of what is called a calcium reactor. This device consists of a column packed with calcium carbonate (CaCO₃) usually in the form of Aragonite. The aquarium saltwater is circulated through this column allowing the CaCO₃ to dissolve adding calcium and HCO₃⁻ to the system. This method has the advantage of adding not only calcium but also maintaining the alkalinity in the aquarium via the HCO₃⁻ addition. Unfortunately, reef aquariums typically operate at pH values of 8.1 to 8.4. At these pH values the CaCO₃ will not effectively dissolve. To allow the saltwater to dissolve the CaCO₃ its pH must be reduced prior to passage through the column. This reduction in pH is facilitated by bubbling carbon dioxide (CO₂) into the aquarium water stream just prior to passage through the column. Though a cost-effective method for maintaining the calcium and alkalinity levels in a reef aquarium, the use of a calcium reactor of this type has a number of disadvantages that become even more evident as the aquariums they are attached to get smaller in volume. These disadvantages stem from the fact that the pH of the aquarium water must be lowered just prior to entrance into the calcium reactor. First, the requirement for pressurized CO₂ availability makes this method expensive, not only for the cylinders of CO₂ but more importantly because of the controls required to add the proper amount of this gas. Too little addition and the CaCO₃ will not dissolve, too much and the pH of the water returning to the aquarium will be too low thus endangering the animals therein. As a result of these issues, calcium reactors are only cost effective in larger systems where their initial capital cost is a small enough fraction of the entire system.

The final way to maintain the calcium levels in a reef aquarium is by the addition of calcium hydroxide (Ca(OH)₂) or Pickling lime in what has been traditionally called a Kalkwasser Reactor. When dissolved in water the Ca(OH)₂ not only adds calcium to the system but also maintains the aquarium's alkalinity via addition of OH⁻. The fact that Pickling lime (or food-grade Lime) is so cheap also adds to the advantages of this method. There are a few challenges to adding Ca(OH)₂ to a reef aquarium. The first of these is that Ca(OH)₂ is only sparingly soluble in water. Because of this in order to maintain a saturated solution added to the aquarium only small amounts of this material can be added to the water at a time. This problem is solved by always maintaining a significant amount of undissolved Ca(OH)₂ in contact with the saturated solution. This is facilitated by always having a layer of solid Ca(OH)₂ at the bottom of a container that adds water to the aquarium and mixing it from time to time. Another consideration for a Ca(OH)₂ addition system is the minimization of air input. The water that is mixed with the Ca(OH)₂ will naturally contain a small amount of dissolved CO₂. This CO₂ will react with the Ca(OH)₂ forming insoluble CaCO₃. To minimize the CO₂ input into this system the Kalkwasser Reactor is either an enclosed device or one in which the water-air interface is left undisturbed (to minimize dissolution of CO₂). The final consideration for this type of calcium addition is to ensure that no solid Ca(OH)₂ is transported into the aquarium itself which can cause a large increase in pH which is damaging to the aquatic life therein. To prevent this unwanted transport of solids these solids must be given time to settle prior to pumping the clarified, saturated liquid into the aquarium. The current art uses pumps or mechanical stirrers to contact the solid and liquid in the mixer. In this current art the device must be designed so that mixing does not occur at the same time as transport of liquid into the aquarium to prevent the unwanted transport of solid Ca(OH)₂. Since the water that supplies the mixer is usually added automatically, many times as part of a fresh water top-off system, controls must be included to ensure that this addition does not occur at the same time as mixing in the device. The present invention takes advantages of the cheap and simple nature of a traditional Kalkwasser Reactor but minimizes its cost and increases its reliability by allowing addition and mixing co currently while doing so with a device that has no moving parts.

### BRIEF SUMMARY OF THE INVENTION

The present invention involves modifying a traditional Kalkwasser Reactor-type mixer so that it can be operated without moving parts or a mixing device (i.e. a pump or mechanical stirrer) and allow this mixing to occur co currently with addition of the saturated, clarified Ca(OH)₂ liquid into an aquarium. This is done by taking advantage of the fresh water that always must be added to a saltwater aquarium to compensate for evaporation. The flow of this water is concentrated and directed in such a way so that it provides the motive force for mixing of the solid Ca(OH)₂ in the device. The device is also configured such that as the fresh water travels through it there is enough time so that the solids entrained during mixing cannot reach the liquid outlet during a typical addition cycle.

The mixing is facilitated by directing the inlet fresh water through a nozzle so that the velocity of this liquid is increased significantly. The solid Ca(OH)₂ is stored in the device such that it is near this nozzle outlet and contained in a small enough area such that the impingement of the accelerated liquid can cause intense solid-liquid contact. As the liquid travels from the mixing area to the outlet of the device the cross-sectional area is increased dramatically. This increase significantly lowers the velocity of the solid-liquid mixture. The direction of flow through the device is upward to the outlet so that this lowering of velocity provides time for the solids in the mixture to settle out.

Thus Ca(OH)₂ mixing occurs in a device without any moving parts, the potential of addition of solid Ca(OH)₂ into an aquarium is minimized, and saturated Ca(OH)2 liquid addition to an aquarium is facilitated without the need for a complicated and expensive control system.

### BRIEF DESCRIPTION OF THE SEVERAL VIEWS OF THE DRAWING

FIG. 1 is an isometric of the Calcium Hydroxide Mixing Device.

FIG. 2 is a front elevation of the Calcium Hydroxide Mixing Device.

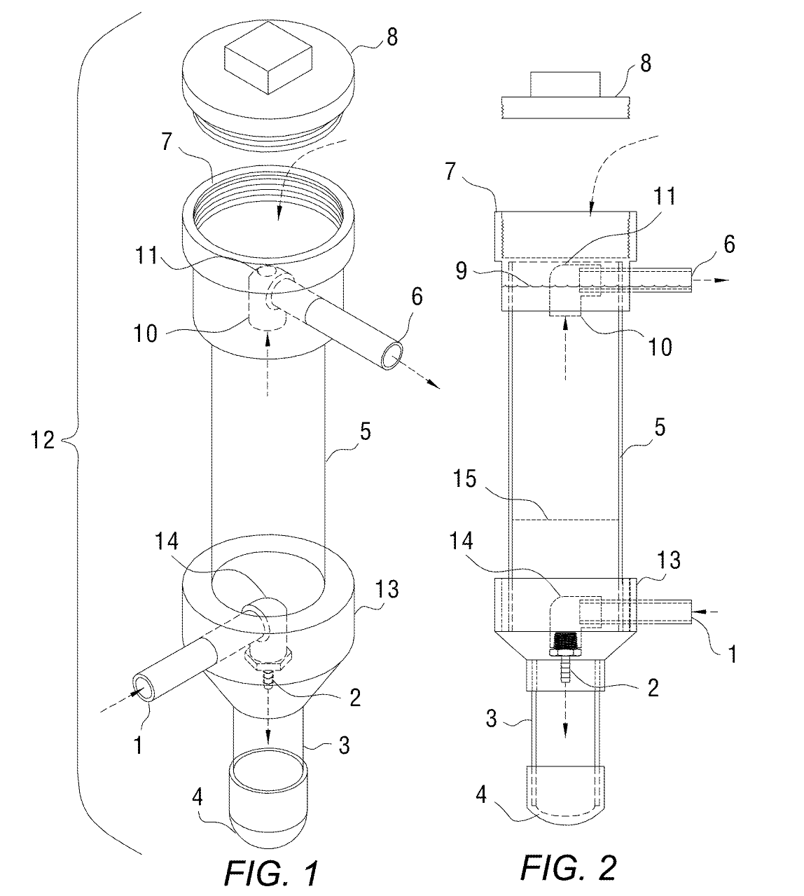

### DETAILED DESCRIPTION OF THE INVENTION

The invention is a Calcium Hydroxide Mixing Device 12 that consists of a vertically positioned column of two distinct diameters. The components of this device can be constructed of various materials, plastic, glass, metal, depending on the requirements of the application at hand. The major part of the column consists of a large diameter cylinder 5. Below this is shorter length cylinder 3 of a smaller diameter. These two cylinders are connected by a concentric reducer 13 that smoothly transitions between the diameters of these two cylinders. The bottom of the shorter length cylinder 3 is sealed with a cap 4 whose inner configuration is of semi-circular, parabolic, conical, or other curved shape that minimizes the areas where material can be trapped during operation. Near the point in the device where the concentric reducer 13 is located an inlet pipe 1 enters the device. Attached to the end of this inlet pipe 1, inside the device, is an elbow 14 that has its outlet oriented downwards towards the cap 4. On the outlet of this elbow 14 is attached a nozzle 2 that has its outlet pointed downward towards the cap 4. The outlet diameter of the nozzle 2 is significantly smaller than that of the inlet pipe 1 which in turn has a significantly smaller diameter than the shorter length cylinder 3.

Mounted above the concentric reducer 13 on the device is the large diameter cylinder 5. Mounted at the top of the large diameter cylinder 5 is an enclosable top 7 that can be sealed from the outside environment by a removable lid 8. Near the enclosable top 7 an outlet pipe 6 enters the device in a like manner as the inlet pipe 1 entered the device through the concentric reducer 13 below it. At the end of this outlet pipe 6 inside the device is a top elbow 10 that has its outlet pointed downward towards the cap 4.

To operate the device first water is added via the inlet pipe 1. This water flows through the inlet pipe 1 to the elbow 14 through the nozzle 2 and into the cap 4. The water accumulates in the device filling first the cap 4 then the shorter length cylinder 3, then the concentric reducer 13, then the large diameter cylinder 5. As it reaches the top of the device and starts to enter the enclosable top 7 the water also enters the downward pointing top elbow 10 and subsequently into the outlet pipe 6 and then leaves the device. During this process the water does not flow out the top of the enclosable top 7 because the orientation of the outlet pipe 6 establishes a constant liquid level at position 9 in FIG. 2. A vent hole 11 can be present in the top of the top elbow 10 to prevent back siphoning of liquid from outlet pipe 6 when the flow into inlet pipe 1 is shut off.

Once a constant liquid level is established at position 9 the water flow into inlet pipe 1 is stopped. At this time removable lid 8 is separated from the enclosable top 7 allowing open access to the top of the device. Through the now present opening in enclosable top 7 calcium hydroxide solid (Ca(OH)₂) is added and then the removable lid 8 is replaced, sealing the device. The device is then allowed to sit still for an appropriate time, 30 minutes to a few hours, so that the calcium hydroxide solid is able to settle into the bottom of the device (i.e. the cap 4 and shorter length cylinder 3).

After the calcium hydroxide solid has been allowed to settle the device is now ready for normal operation. During normal operation water periodically enters the device through the inlet pipe 1 for a short period of time usually as part of a top-off water system required for most saltwater aquariums. During this addition the water flows through the inlet pipe 1, the elbow 14, and finally out the nozzle 2. In one embodiment of this device the flow rate into the inlet pipe 1 and the diameter of the nozzle 2 are such that the resulting water velocity leaving nozzle 2 exceeds 28 inches/second. This fast moving water impinges on the calcium hydroxide solids that have settled in the cap 4 and shorter length cylinder 3 causing the two to mix thoroughly. The distance from the end of the nozzle 2 and the bottom of the cap 4 should be short enough so that the fast moving water leaving the nozzle 2 retains enough of its speed to facilitate good mixing yet long enough to allow an appreciable amount of calcium hydroxide solid to be retained in the bottom of the device during operation over a few weeks or months. In one embodiment of this device this distance is approximately 4.5 inches. The inner configuration of the cap 4 is such that it promotes mixing when the solids present there are impinged by the fast moving water from nozzle 2 while also minimizing “dead” spots where calcium hydroxide solid could be isolated from this mixing process.

As this water flow in through inlet pipe 1 continues and mixing is produced in the cap 4 and shorter length cylinder 3, the liquid in the device becomes saturated with dissolved calcium hydroxide. Since the liquid level in the device is already at position 9 liquid immediately starts flowing out of the device through outlet pipe 6 as soon as water starts flowing into inlet pipe 1. In another embodiment of this device the final destination of the liquid effluent is higher than outlet pipe 6. In this embodiment no air-liquid interface forms at position 9 and the liquid level in the device fills all the way to the removable lid 8 upon liquid filling the device via inlet pipe 1.

As the mixing continues in the bottom of the device some of the calcium hydroxide solid is entrained in the mass of liquid that is slowly moving upward to the outlet pipe 6. This entrained solid-liquid mixture forms an interface 15 as it moves upward. As this interface 15 moves out of the shorter length cylinder 3 through the concentric reducer 13 and into the large diameter cylinder 5 its upward speed slows due to its larger diameter.

In one embodiment of this device to facilitate proper mixing the ratio of the diameter of the shorter length cylinder 3 to the diameter of the nozzle 2 should be no larger than approximately 13. Denoting the ratio between these two diameters as a design parameter for the device allows this dimensionless number to guide the design of devices of various sizes to accommodate various size aquariums or other similar applications.

In one embodiment of this device the diameter and length of the large diameter cylinder 5 is such that the volume of water displaced through the device during a typical periodic filling event is such that the solid-liquid interface 15 traveling up the device never reaches the top elbow 10 and thus does not allow solids to travel out of the device through the outlet pipe 6 and thus into the aquarium.

In another embodiment of this device the diameter and length of the large diameter cylinder 5 is such that the velocity of the solid-liquid interface 15 traveling up the device is slow enough that the solid Ca(OH)2 present settles by gravity prior to reaching the top elbow 10 and thus does not allow solids to travel out of the device through the outlet pipe 6 and thus into the aquarium.

In one embodiment of this device the top elbow 10 is oriented so that it is pointed downward so that this opening is always beneath the liquid level at position 9. This prevents any calcium hydroxide solid that may accumulate at the air-liquid interface at position 9 from traveling out of the device and into the aquarium. It also keeps the air-liquid interface at position 9 sufficiently still so that dissolution of CO₂ into this liquid is minimized and thus the conversion of Ca(OH)₂ to CaCO₃ is minimized.

I claim:

1. A method of making a Mixing Device comprising of a construction such that it has no moving parts.

2. A method of making a Mixing Device in accordance with claim 1 wherein thereof is constructed such that it uses increased velocity of liquid to facilitate mixing of a liquid and a solid.

3. A method of making a Mixing Device in accordance with claim 1 wherein thereof is constructed such that a decrease in velocity is used to facilitate separation of a solid-liquid mixture.

4. A method of making a Mixing Device in accordance with claim 1 wherein thereof is constructed of materials compatible with various industrial and commercial applications.

5. A method of making a Mixing Device comprising:
(A) a large diameter, vertically oriented, cylinder
(B) a small diameter, vertically oriented, cylinder mounted below said large diameter, vertically oriented, cylinder
(C) a vertically oriented, concentric transition piece connecting said large diameter, vertically oriented, cylinder and small diameter, vertically oriented, cylinder
(D) an enclosable top mounted at the top of said large diameter, vertically oriented, cylinder
(E) a lid used to seal the opening in said enclosable top
(F) a cap mounted on the bottom end of said small diameter, vertically oriented, cylinder enclosing this end of the device
(G) an inlet pipe integral to said concentric transition piece
(H) an elbow connected to the end of said inlet pipe inside said concentric transition piece with its outlet pointing in a downward orientation
(I) a nozzle connected to the outlet of said elbow of smaller diameter than that of said inlet pipe
(J) an outlet pipe integral to said enclosable top
(K) an elbow connected to the end of said outlet pipe inside said enclosable top with its open end pointing in a downward orientation

6. A method of making a Mixing Device in accordance with claim 5 wherein thereof is constructed of materials that are compatible with generally used mixing applications.

7. A method of making a Mixing Device in accordance with claim 5 wherein said large diameter, vertically oriented, cylinder is of a predetermined diameter and length.

8. A method of making a Mixing Device in accordance with claim 5 wherein said small diameter, vertically oriented, cylinder is of a predetermined diameter and length.

9. A method of making a Mixing Device in accordance with claim 5 wherein said inlet pipe is of a predetermined diameter.

10. A method of making a Mixing Device in accordance with claim 5 wherein said outlet pipe is of a predetermined diameter.

11. A method of making a Mixing Device in accordance with claim 5 wherein said elbow is of a predetermined angle and attached to the inside end of said inlet pipe and pointed in a downward direction.

12. A method of making a Mixing Device in accordance with claim 5 wherein said nozzle is of a predetermined diameter and a predetermined distance above said cap.

13. A method of making a Mixing Device in accordance with claim 5 wherein said cap is of a predetermined semi-circular, parabolic, conical, or other curved shape that minimizes the areas where material can be trapped.

14. A method of making a Mixing Device in accordance with claim 5 wherein said top elbow is of a predetermined angle and attached to the inside end of said outlet pipe and pointed in a downward direction.

15. A method of making a Mixing Device in accordance with claim 5 wherein opening of said downward pointing top elbow is a predetermined distance below bottom of said outlet pipe.

16. A method of making a Mixing Device in accordance with claim 5 wherein said lid is removable.

17. A method of making a Mixing Device in accordance with claim 5 wherein said lid and said enclosable top can form an airtight seal.
